(19) United States
(12) Patent Application Publication
(10) Pub. No.: US 2017/0369754 A1
(43) Pub. Date: Dec. 28, 2017

(54) WORKING MEDIUM FOR HEAT CYCLE

(71) Applicant: DENSO CORPORATION, Kariya-city, Aichi-pref (JP)

(72) Inventor: Shin NISHIDA, Kariya-city (JP)

(21) Appl. No.: 15/539,556

(22) PCT Filed: Jan. 7, 2016
(86) PCT No.: PCT/JP2016/050389

§ 371 Date: Jun. 23, 2017

(30) Foreign Application Priority Data
Jan. 16, 2015 (JP) 2015-007068

(51) Int. Cl. C09K 5/04; F25B 1/08; C10M 171/00; F25B 9/00

(52) U.S. Cl. CPC C09K 5/047; F25B 9/006; F25B 1/08; C10M 171/008; C09K 2205/22

(57) ABSTRACT

A working medium for a heat cycle includes HFO-1123, HFC-32, and HFO-1234ze. These three components HFO-1123, HFC-32, and HFO-1234ze are present as principal components in a mixture state.

### CROSS REFERENCE TO RELATED APPLICATION

This application is based on Japanese Patent Application No. 2015-7068 filed on Jan. 16, 2015, the disclosure of which is incorporated herein by reference.

### TECHNICAL FIELD

The present disclosure relates to a working medium for a heat cycle.

### BACKGROUND ART

As a working medium for a heat cycle, which is typically used in heat cycle devices such as refrigeration cycle devices, Rankine cycle devices, heat pump cycle devices, and heat transport devices, Patent Literature 1 discloses a mixture of two components of HFO-1123 and HFC-32. Such a working medium for heat cycle is hereinafter also simply referred to as a “working medium”. The working medium made of the mixture of HFO-1123 and HFC-32 has excellent cycling performance because of the HFO-1123 being included.

### PRIOR ART LITERATURE

### Patent Literature

Patent Literature 1: WO 2012/157764 A1

### SUMMARY OF INVENTION

The mixture of HFO-1123 and HFC-32, however, has disadvantages as follows.

Such a working medium requires low GWPs (abbreviation of global warming potential) so as to less affect global warming. However, the mixture of HFO-1123 and HFC-32 has a high GWP, because HFC-32 has a high GWP of 675.

The mixture of HFO-1123 and HFC-32 has a low critical temperature, because both of HFC-32 and HFO-1123 have low critical temperatures of 78.1° C. and 59.2° C. respectively. For example, an on-vehicle refrigeration cycle device may be used under high-temperature conditions in which air for use in heat exchange with a refrigerant in a heat radiator has a high temperature. In this case, the refrigerant is desired to have a high critical temperature, because the refrigerant, if having a low critical temperature, offers low refrigeration capacity (that is, low cycling performance) owing to the properties of the refrigerant. Refrigerants for use in other heat cycle devices also preferably have high critical temperatures.

It is an object of the present disclosure to provide a working medium for a heat cycle including HFO-1123 and HFC-32, and having a lower GWP and a higher critical temperature than those of a working medium made of a mixture of two components of HFO-1123 and HFC-32.

According to a first aspect, a working medium for a heat cycle includes HFO-1123, HFC-32, and HFO-1234ze. The three components, HFO-1123, HFC-32, and HFO-1234ze are present as principal components in a mixture state.

HFO-1234ze has an extremely lower GWP as compared with HFC-32. HFO-1234ze has an extremely higher critical temperature as compared with HFO-1123 and HFC-32.

Accordingly, in the first aspect, a mixture of HFO-1123 and HFC-32 is further combined with HFO-1234ze, which has a low GWP and a high critical temperature. This allows the working medium to have a lower GWP and a higher critical temperature as compared with the working medium made of two components of HFO-1123 and HFC-32.

According to a second aspect, the working medium for a heat cycle further includes HFO-1234yf. The four components, HFO-1123, HFC-32, HFO-1234ze, and HFO-1234yf, are present as principal components in a mixture state.

HFO-1234yf has an extremely lower GWP as compared with HFC-32. HFO-1234yf has an extremely higher critical temperature as compared with HFO-1123 and HFC-32.

Accordingly, in the second aspect, HFO-1123 and HFC-32 are combined with HFO-1234ze and HFO-1234yf, which have low GWPs and high critical temperatures. This allows the working medium to have a lower GWP and a higher critical temperature as compared with the working medium made of the mixture of the two components, HFO-1123 and HFC-32.

### BRIEF DESCRIPTION OF DRAWINGS

The above and other objects, features and advantages of the present disclosure will become more apparent from the following detailed description made with reference to the accompanying drawings, in which like parts are designated by like reference numbers and in which:

FIG. 1 is a diagram illustrating the configuration of a refrigeration cycle device according to a first embodiment;

FIG. 2 is a diagram illustrating, on a Mollier diagram of HFC-32 alone, a change in state of a refrigerant in a refrigeration cycle in which a condensing temperature of the refrigerant is 75° C.;

FIG. 3 is a diagram illustrating, on a Mollier diagram of HFC-32 alone, a change in state of a refrigerant in a refrigeration cycle in which the refrigerant after heat exchange with air in a heat radiator has a temperature of 85° C.;

FIG. 4 is a graph illustrating a relationship between GWP of a refrigerant in a mixture state of the three components, HFO-1123, HFC-32, and HFO-1234ze according to the first embodiment and a mixing proportion of HFO-1234ze relative to the total mass of the three components;

FIG. 5 is a triangular diagram illustrating a range of the mixing ratio of the three components in the refrigerant according to the first embodiment, where, in the range, the ratio of HFO-1123 to HFO-1123 is from 4:6 to 6:4 and the mixture of the four components has a GWP of 150 or less;

FIG. 6 is a graph illustrating a relationship between GWP of a refrigerant in a mixture state of the four components, HFO-1123, HFC-32, HFO-1234ze, and HFO-1234yf according to a second embodiment and a mixing proportion of a mixture of HFO-1234ze and HFO-1234yf relative to the total mass of the four components; and

FIG. 7 is a triangular diagram illustrating a range of the mixing ratio of the four components in the refrigerant according to the second embodiment, where, in the range, the ratio of HFO-1123 to HFO-1123 is from 4:6 to 6:4 and that the mixture of the four components has a GWP of 150 or less.

### DESCRIPTION OF EMBODIMENTS

Hereinafter, embodiments of the present disclosure will be described with reference to the drawings. Portions or parts that are identical or equivalent to each other in the following embodiments will be explained with an identical reference sign.

### First Embodiment

In the present embodiment, there is described an example in which the working medium according to the present disclosure is applied to a refrigerant for use in a vapor compression refrigeration cycle device of an on-vehicle air conditioner.

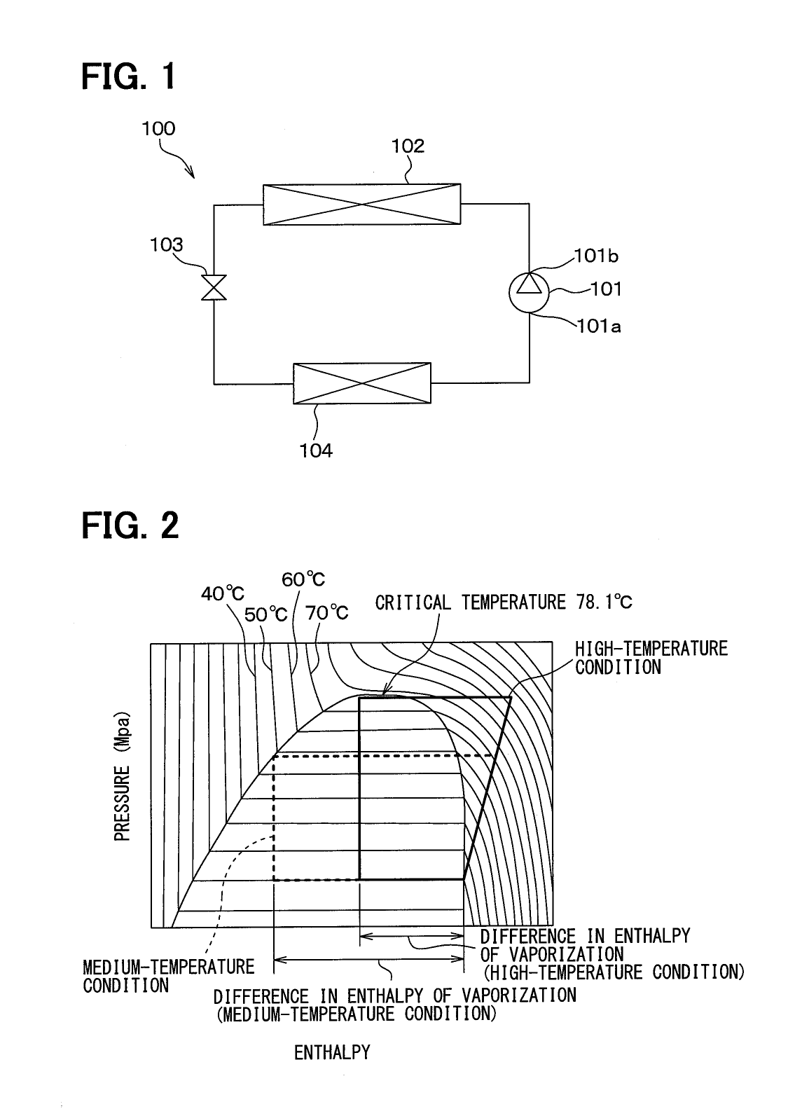

As illustrated in FIG. 1, the refrigeration cycle device 100 of the present embodiment includes a compressor 101, a condenser 102, an expansion valve 103, and an evaporator 104. The compressor 101, the condenser 102, the expansion valve 103, and the evaporator 104 are sequentially coupled to each other through piping.

The compressor 101 has a refrigerant inlet 101a and a refrigerant outlet 101b. The compressor 101 compresses the refrigerant taken from the refrigerant inlet 101a, and discharges the compressed refrigerant from the refrigerant outlet 101b. The condenser 102 is a heat radiator, which allows the vapor-phase refrigerant discharged from the compressor 101 to dissipate heat via heat exchange with vehicle exterior air (that is, outside air). The expansion valve 103 is a decompressor that decompresses and expands the refrigerant discharged from the condenser 102. The evaporator 104 allows the refrigerant decompressed by the expansion valve 103 to absorb heat and to evaporate via heat exchange with air to be supplied toward the vehicle interior. The refrigerant discharged from the evaporator 104 is fed to the compressor 101.

The refrigerant of the present embodiment includes HFO-1123 (1,1,2-trifluoroethylene), HFC-32 (difluoromethane), and HFO-1234ze (1,3,3,3-tetrafluoropropene), in which the three components are present as principal components in a mixture state.

The refrigerant according to the present embodiment is not limited to one made of only the three components. The refrigerant of the present embodiment may include one or more other working mediums in addition to the three components, as long as the three components are present as principal components in a mixture state. The phrase “the three components are present as principal components in a mixture state” refers to and means that the total mass of the three components is larger than the mass of the other working medium(s). When the refrigerant includes two or more different other working mediums, the phrase means that the total mass of the three components is larger than the mass of each of the other working mediums. The refrigerant of the present embodiment may be used in combination with one or more other components than working mediums, where the other components are for use in combination with such refrigerants. Non-limiting examples of the other components than working mediums include lubricating oils, desiccants, and other additives.

HFO-1234ze has two isomers, E-form and Z-form, by difference in arrangement of atoms in the molecule. In the present description, the E-form is indicated as HFO-1234ze (E), and the Z-form is indicated as HFO-1234ze (Z). In the present description, the term “HFO-1234ze” refers to any of the case where the HFO-1234ze includes HFO-1234ze (E) alone, the case where the HFO-1234ze includes both HFO-1234ze (E) and HFO-1234ze (Z) in combination, and the case where the HFO-1234ze includes HFO-1234ze (Z) alone.

The properties of the refrigerant of the present embodiment will be described, with the properties of a refrigerant which is a two-component mixture refrigerant of HFO-1123 and HFC-32 as a comparative example.

Table 1 presents the properties of the individual refrigerants when used alone. The values of the properties given in Table 1 are cited from the values of the properties described in the following literature and articles.

Name of Literature: The International Symposium on New Refrigerant and Environmental Technology 2014

Article numbers: JRAIA2014KOBE-0801, JRAIA2014KOBE-0805, and JRAIA2014KOBE-0806

Table 2 presents the properties of mixture refrigerants of Comparative Examples 1 and 2. The GWPs and the critical temperatures given in Table 2 are calculated on the basis of the values in Table 1. The refrigerants of Comparative Examples 1 and 2 include HFO-1123 and HFC-32 in mixing ratios of HFO-1123 to HFC-32 of 50:50 (in mass percent) and 60:40 (in mass percent), respectively. The mixing ratios are defined while the total mass of HFO-1123 and HFC-32 is defined as 100 mass percent.

TABLE 1

| | HFO1123 | HFC32 | HFO1234ze(E) | HFO1234ze(Z) | HFO1234yf | HFC134a |
|---|---|---|---|---|---|---|
| Boiling point (° C.) | −56 | −51 | −19 | 9.7 | −29 | −26 |
| Critical temperature | 59.2 | 78.1 | 109.4 | 150.1 | 94.7 | 100.9 |
| (° C.) | | | | | | |
| GWP | 0.3 | 675 | 1 | 1 | 1 | 1430 |
| Combustibility | slightly | slightly | slightly | slightly | slightly | incombustible |
| | combustible | combustible | combustible | combustible | combustible | |
| Burning rate | unburnt | 9 | 5 | unburnt | 3 | incombustible |
| (cm · S⁻¹) | | | | | | |
| Disproportionation | present | absent | absent | absent | absent | absent |

TABLE 2

| | Comparative Example 1 | | Comparative Example 2 | |
|---|---|---|---|---|
| | HFO1123 | HFC32 | HFO1123 | HFC32 |
| Mixing ratio | 50 | 50 | 60 | 40 |
| (mass percent) | | | | |

| | | |
|---|---|---|
| Critical | around 68° C. | around 67° C. |
| temperature (° C.) | | |
| GWP | about 340 | about 270 |
| Combustibility | slightly combustible | slightly combustible |
| Disproportionation | absent (practically usable | absent (practically usable |
| | range) | range) |

Initially, the properties of the two-component mixture refrigerant of HFO-1123 and HFC-32 will be described.

(1) GWP (Global Warming Potential)

As presented in Table 1, HFO-1123 has an extremely low GWP of 0.3, whereas HFC-32 has a high GWP of 675. As a result, the GWP of the two-component mixture refrigerant increases with an increase in mixing proportion of HFC-32. Specifically, the mixture refrigerant of Comparative Example 1 has a GWP of about 340, and the mixture refrigerant of Comparative Example 2 has a GWP of about 270, both of which GWPs are high, as presented in Table 2.

(2) Critical Temperature

HFO-1123 has a low critical temperature of 59.2° C., and HFC-32 also has a low critical temperature of 78.1° C., as presented in Table 1. The two-component mixture refrigerant therefore has a low critical temperature between 59.2° C. to 78.1° C. inclusive. Specifically, the mixture refrigerant of Comparative Example 1 has a critical temperature of around 68° C., and the mixture refrigerant of Comparative Example 2 has a critical temperature of around 67° C., as presented in Table 2.

When the two-component mixture refrigerant is used in a refrigeration cycle device of an on-vehicle air conditioner, the refrigerant may be subjected to an operation under high-temperature conditions in which the air to cool the condenser 102 has a relatively high temperature. In such a case, the on-vehicle air conditioner may disadvantageously suffer from reduced cooling performance. This is because the temperature of the refrigerant after heat exchange is lower than, but close to the critical temperature, or is higher than the critical temperature.

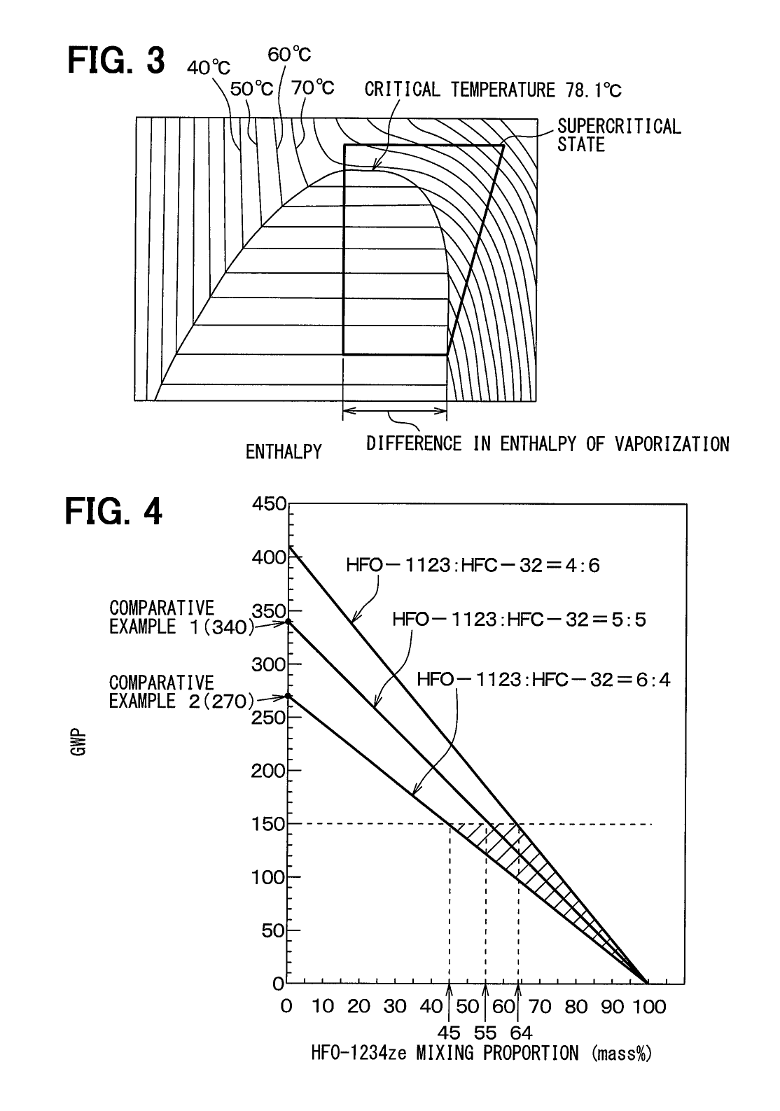

The reduction in cooling performance will be described below, with reference to FIGS. 2 and 3.

In household and industrial air conditioners, the refrigerant condensing temperature in the condenser, that is, the temperature of the refrigerant after heat exchange with the air is higher than the outside air temperature by several degrees centigrade (° C.) to several tens of degrees centigrade. For example, when the outside air temperature is 40° C., the cooling air temperature, which is the temperature of air to cool the condenser, is around 45° C., and the refrigerant condensing temperature is 50° C. to 60° C. In contrast, in on-vehicle air conditioners, the condenser 102 is disposed adjacent to an engine, which generates heat. In addition, the heat generated by the engine may be persisting internally in the engine compartment when the vehicle is in a parked state. These may cause the temperature of the air, which cools the condenser 102, to rise higher than the outside air temperature by nearly 20° C. For example, when the outside air temperature is 40° C., the cooling air temperature becomes around 60° C., and the refrigerant condensing temperature is 65° C. to 75° C. In the Middle and Near East and other areas where the outside air temperature is extremely high, when the outside air temperature is 50° C., the cooling air temperature becomes around 70° C., and the refrigerant condensing temperature is 75° C. to 85° C. As described above, the operation in the on-vehicle air conditioners may be performed under high-temperature conditions in which the temperature of the air to cool the condenser 102 is higher (that is, higher refrigerant condensing temperature) as compared with household and industrial air conditioners.

FIG. 2 is a diagram illustrating, on a Mollier diagram (that is, P-h diagram) of HFC-32 which has a critical temperature of 78.1° C., a change of the state of the refrigerant in a refrigeration cycle in which the refrigerant condensing temperature is 75° C. The refrigerant condensing temperature, when being 75° C., is near to the critical temperature, and the enthalpy does not decrease upon the completion of condensation of the refrigerant. Thus, the operation under such high-temperature conditions gives a significantly reduced difference in enthalpy as compared with an operation under medium-temperature conditions, where the difference in enthalpy is an enthalpy difference (that is, difference in enthalpy of vaporization) between the inlet and the outlet of the evaporator 104. It is understood that this causes the evaporator 104 to have significantly reduced cooling performance.

FIG. 3 is a diagram illustrating, on a Mollier diagram (that is, P-h diagram) of HFC-32 which has a critical temperature of 78.1° C., a change of the state of the refrigerant in a refrigeration cycle where the refrigerant after heat exchange with air in a heat radiator has a temperature of 85° C. The heat radiator corresponds to the condenser 102 in FIG. 1. In this case, the operation is a supercritical operation in which the refrigerant after heat exchange with air in the heat radiator has a temperature higher than the critical temperature, and the enthalpy does not decrease upon the completion of heat dissipation of the refrigerant. Thus, as with the operation under high-temperature conditions given in FIG. 2, the operation under such supercritical conditions has a significantly reduced difference in enthalpy of vaporization as compared with the operation under medium temperature conditions as illustrated in FIG. 2. The evaporator 104 therefore suffers from significantly reduced cooling performance. In such a supercritical-pressure operation, the refrigerant is in a supercritical state even at the outlet of the heat radiator. This impedes a vapor-liquid separation mechanism by a receiver in a refrigeration cycle using the receiver, and this in turn requires significant changes or modifications of the refrigeration cycle itself.

The mixture refrigerants of Comparative Examples 1 and 2 have critical temperatures lower than the critical temperature of HFC-32, and this demonstrates that the mixture refrigerants of Comparative Examples 1 and 2 suffer from the disadvantages as with HFC-32.

(3) Combustibility and Disproportionation

The two-component mixture refrigerants are known to have to include HFC-32 in a high mixing ratio, so as to restrain the disproportionation of HFO-1123. In a comparison in burning rate, which is an index for combustibility, HFC-32 has a higher burning rate as compared with HFO-1234yf as presented in Table 1, where HFO-1234yf is practically used as an on-vehicle refrigerant. This requires the restrainment or reduction of combustibility.

The two-component mixture refrigerants are hardly usable as on-vehicle refrigerants, for the reasons (1) to (3) above. By contrast, the two-component mixture refrigerants have extremely higher cooling performance (that is, cooling capacity), which is a basic performance as refrigerants, as compared with HFC134a which is practically used as an on-vehicle refrigerant. For example, the mixture refrigerants of Comparative Examples 1 and 2 offer extremely high cooling performance as much as about 2.5 times the cooling performance of HFC134a. Accordingly, it is expected to solve the disadvantages by incorporating one or more other refrigerant components into the two-component mixture refrigerant as a basic refrigerant component.

In contrast, HFO-1234ze has following specificities, as given in Table 1.

(1) GWP

HFO-1234ze has a GWP of 1, as low as with other hydrofluoroolefin (HFO) refrigerants which have been increasingly practically used. HFO-1234yf has been practically used because of having such safety and temperature-pressure characteristics as to be usable as an on-vehicle refrigerant. HFO-1234ze has properties relatively close to those of HFO-1234yf and is an object to be examined as another refrigerant component to be incorporated into the two-component mixture refrigerant.

(2) Critical Temperature

The critical temperature of HFO-1234ze is a striking property. Specifically, HFO-1234ze (E) and HFO-1234ze (Z) have extremely higher critical temperatures of 109.4° C. and 150.1° C., respectively, as compared with other refrigerants. This property allows the resulting mixture refrigerant to have a higher critical temperature effectively.

(3) Combustibility

HFO-1234ze has a burning rate which is lower than the burning rate of HFO-32 and which is close to the burning rate of HFO-1234yf. This allows the resulting mixture refrigerant to have combustibility controlled within such a range as to be acceptable as an on-vehicle refrigerant.

These demonstrate that HFO-1234ze is optimum as a refrigerant that meets the requirements, among refrigerants examined as refrigerants for air conditioning.

Next, the properties of the refrigerant of the present embodiment will be described.

(1) GWP

As described above, a mixture refrigerant of HFO-1123 and HFC-32, when further combined with HFO-1234ze which has a low GWP, can have a lower GWP as compared with the two-component mixture refrigerant.

FIG. 4 illustrates a relationship between the GWP of a mixture of three components HFO-1123, HFC-32, and HFO-1234ze and the mixing ratio (that is, mixing proportion) of HFO-1234ze. The “mixing proportion of HFO-1234ze” refers to the proportion of HFO-1234ze relative to the total mass of the three components, provided that the total mass of the three components is defined as 100 mass percent. The straight lines in FIG. 4 illustrating the relationship between the GWP and the mixing proportion of HFO-1234ze are plotted as a result of calculation using the GWPs given in Table 1, at mixing ratios (in mass ratios) of HFO-1123 to HFC-32 of 4:6, 5:5, and 6:4. As demonstrated by Table 1, HFO-1234ze (E) and HFO-1234ze (Z) have identical GWPs. Thus, the HFO-1234ze in FIG. 4 may be any one of a HFO-1234ze including HFO-1234ze (E) alone, a HFO-1234ze including both HFO-1234ze (E) and HFO-1234ze (Z) in combination, and a HFO-1234ze including HFO-1234ze (Z) alone.

FIG. 4 demonstrates that a refrigerant, when further including HFO-1234ze, has a lower GWP as compared with the mixture refrigerants of Comparative Examples 1 and 2, when compared at the same mixing ratio of HFO-1123 to HFC-32.

(2) Critical Temperature

As described above, a mixture refrigerant of HFO-1123 and HFC-32, when further combined with HFO-1234ze which has a high critical temperature, can have a higher critical temperature as compared with the two-component mixture refrigerant. That is, the resulting mixture refrigerant can have an elevating critical temperature with an increasing proportion of HFO-1234ze relative to the total of the three components.

The refrigerant of the present embodiment can therefore have a higher critical temperature and can solve the disadvantage of reduction in refrigerant performance due to low critical temperature.

HFO-1234ze (Z) has an extremely high critical temperature of 150.1° C., but also has a high boiling point of 9.7° C. The HFO-1234ze for use herein preferably includes HFO-1234ze (E) alone, or preferably includes the both isomers, but contains HFO-1234ze (E) in a larger amount as compared with HFO-1234ze (Z).

(3) Combustibility

As described above, the three-component mixture refrigerant, when containing HFO-32 in a lower proportion and HFO-1234ze in a higher proportion relative to the total amount of the mixture refrigerant, can have lower combustibility as compared with the two-component mixture refrigerant. In other words, the refrigerant of the present embodiment contains HFO-1234ze which has a lower burning rate as compared with HFO-32. This allows the refrigerant of the present embodiment to have lower combustibility as compared with the two-component mixture refrigerant, when compared at the same mixing ratio of HFO-1123 to HFC-32.

Next, the mixing proportions in the refrigerant according to the present embodiment will be described.

On-vehicle refrigerants are required to have GWPs of 150 or less by regulations typically in Europe. The refrigerant according to the present embodiment can have a GWP in a mixture state of the three principal components of 150 or less by appropriately adjusting the mixing proportions of the three components.

Specifically, the mixing proportions of the three components are adjusted within the following ranges.

As illustrated in FIG. 4, the mixing proportions of the three components are adjusted so that the mass proportion of HFO-1234ze relative to the total mass of the three components is 45 mass percent or more, provided that the mass ratio of HFO-1123 to HFC-32 is from 4:6 to 6:4. The mass proportion refers to a mass proportion as determined while the total mass of the three components is defined as 100 mass percent. However, at mass ratios of HFO-1123 to HFC-32 of 5:5 and 4:6, the mass proportions of the three components are adjusted so that the mass proportions of HFO-1234ze are respectively about 55% or more and about 64% or more within such ranges that the resulting refrigerant has a GWP of 150 or less. The “mass ratio of HFO-1123 to HFC-32 of 4:6 to 6:4” refers to a range which is between the mass ratio of HFO-1123 to HFC-32 of 4:6 and the mass ratio of HFO-1123 to HFC-32 of 6:4 and which includes both the mass ratio of HFO-1123 to HFC-32 of 4:6 and the mass ratio of HFO-1123 to HFC-32 of 6:4.

The mass ratio of HFO-1123 to HFC-32 is specified herein as from 4:6 to 6:4 for the following reasons.

HFC32 has a boiling point close to the boiling point of HFO-1123. HFC-32 therefore acts as a pseudo-azeotropic refrigerant with respect to HFO1123. HFO-1234ze has boiling points significantly different from the boiling points of HFO-1123. HFO-1234ze therefore differs in properties from HFO1123.

During a halt of the refrigeration cycle device 100, temperature distribution may occur in individual portions of the refrigeration cycle device 100 to cause unevenness in distribution of the refrigerant components in the refrigeration cycle, due to evaporation and/or condensation phenomenon of the refrigerant. Even in this case, the refrigerant according to the present embodiment can maintain the mixture state of HFO-1123 and HFC-32. If the refrigerant in this state leaks typically from a piping joint of the refrigeration cycle device 100, there may happen the case where, among the three components, HFO-1234ze is preferentially discharged to the outside. In this case, the residual mixture refrigerant in the refrigeration cycle becomes a two-component mixture of HFO-1123 and HFC-32. The mixing ratio of HFO-1123 to HFC-32 is preferably adjusted to such a mixing ratio as to restrain the disproportionation.

The two-component mixture refrigerant of HFO-1123 and HFC-32 is known to less suffer from disproportionation of HFO-1123 by adjusting the mass ratio of HFO-1123 to HFC-32 to the range of from 4:6 to 6:4 (see, for example, “The International Symposium on New Refrigerant and Environmental Technology 2014”, Article Number: JRAIA2014KOBE-0806). Also in the refrigerant of the present embodiment, the mass ratio of HFO-1123 to HFC-32, which is the pseudo-azeotropic refrigerant with respect to the former, is preferably from 4:6 to 6:4 as an insurance against the case where, among the three components, HFO-1234ze alone is discharged to the outside. This configuration can restrain the disproportionation of HFO-1123.

FIG. 4 also demonstrates that the mixture refrigerant has a GWP of 150 or less by adjusting the mixing ratio of HFO-1234ze to 45 mass percent or more, at a mass ratio of HFO-1123 to HFC-32 of 6:4.

Mixture refrigerants having mixing ratios of HFO-1123 to HFC-32 of lower than 6:4 are as follows. That is, the data in FIG. 4 demonstrates that a mixture refrigerant, when having a mixing ratio of HFO-1123 to HFC-32 of 5:5, can have a GWP of 150 or less by containing HFO-1234ze in a mixing proportion of about 55 mass percent or more. The data also demonstrates that a mixture refrigerant, when having a mixing ratio of HFO-1123 to HFC-32 of 4:6, can have a GWP of 150 or less by containing HFO-1234ze in a mixing proportion of about 64 mass percent or more.

On the basis of this, it can be said that the mixture refrigerant has to contain HFO-1234ze in a mixing proportion of at least 45 mass percent or more so as to have a GWP of 150 or less.

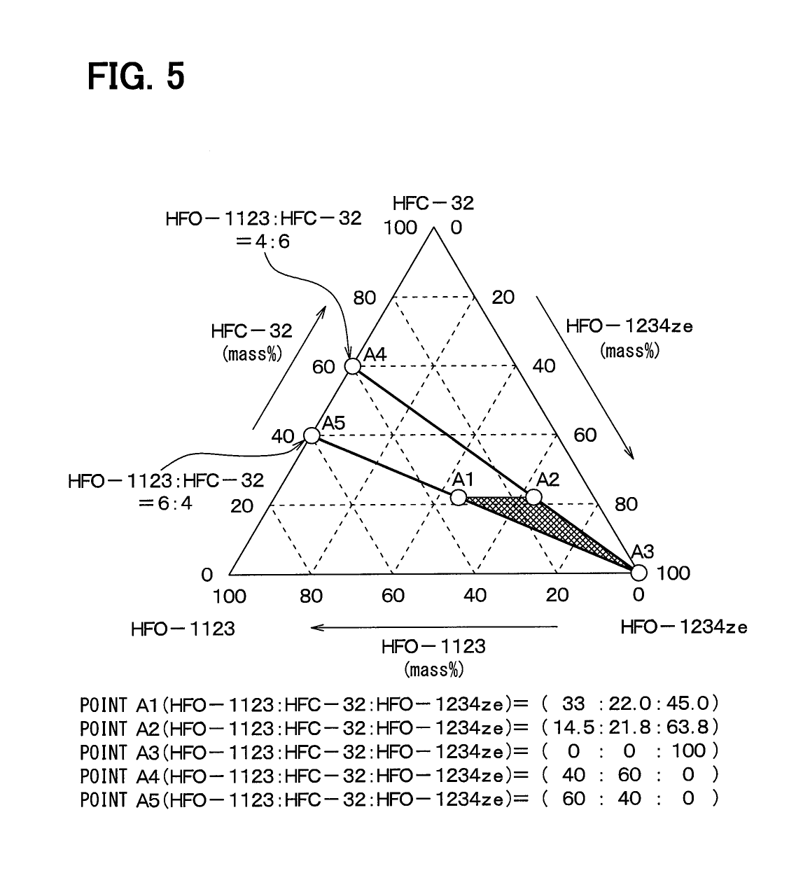

The range of mixing ratio of the three components so as to allow the refrigerant to have a GWP of 150 or less in a mixture state of the three components is plotted on the triangular diagram of the three components in FIG. 5, where the mixing ratio of HFO-1123 to HFC-32 is adjusted in the range of from 4:6 to 6:4. FIG. 5 is a triangular diagram where the total mass of the three components is defined as 100 mass percent, and where points at each of which the mass proportion of one of the three components is 100 mass percent are defined as vertices.

In the triangular diagram illustrated in FIG. 5, the mixing ratio of the three components is adjusted so as to fall within a crosshatched region surrounded by straight lines that connect Point A1, Point A2, and Point A3 in the specified sequence, where the region includes the individual straight lines, but excludes Point A3. This allows the mixture refrigerant to have a GWP of 150 or less in a mixture state of the three components. Point A1, Point A2, and Point A3 are expressed as follows.

Point A1: (HFO-1123:HFC-32:HFO-1234ze=33:22.0:45.0)

Point A2: (HFO-1123:HFC-32:HFO-1234ze=14.5:21.8:63.8)

Point A3: (HFO-1123:HFC-32:HFO-1234ze=0:0:100)

The crosshatched region in FIG. 5 is derived using GWPs calculated by a procedure similar to that in FIG. 4. The straight line connecting between Point A1 and Point A3 in FIG. 5 corresponds to a region at a mixing proportion of HFO-1234ze of 45 mass percent or more, in the straight line at a mixing ratio of HFO-1123 to HFC-32 of 6:4 in FIG. 4. The straight line connecting between Point A2 and Point A3 in FIG. 5 corresponds to a region at a mixing proportion of HFO-1234ze of about 64 (specifically, 63.8) mass percent or more, in the straight line at a mixing ratio of HFO-1123 to HFC-32 of 4:6 in FIG. 4.

When HFO-1234ze includes both HFO-1234ze (E) and HFO-1234ze (Z) in combination, the term “mass proportion of HFO-1234ze” in FIGS. 4 and 5 refers to the mass proportion of the total mass of the two isomers.

The refrigerant of the present embodiment preferably has a mixing ratio of the three components of any of the mixing ratios as specified in Examples 1 and 2. Table 3 presents the mixing ratios and the properties of the refrigerants of Examples 1 and 2. Table 3 also presents the mixing ratio and the properties of the refrigerant of Comparative Example 1.

TABLE 3

| | Comparative | | | | | | | | Comparative |
|---|---|---|---|---|---|---|---|---|---|
| | Example 1 | | Example 1 | | | Example 2 | | | Example 3 |
| | HFO1123 | HFC32 | HFO1123 | HFC32 | HFO1234ze(E) | HFO1123 | HFC32 | HFO1234ze(E) | HFO1234yf |
| Mixing ratio | 50 | 50 | 33 | 22.0 | 45.0 | 14.5 | 21.8 | 63.8 | 100 |
| (mass percent) | | | | | | | | | |

| | | | | |
|---|---|---|---|---|
| Critical | around 68° C. | around 86° C. | around 95° C. | 94.7 |
| temperature (° C.) | | | | |
| GWP | about 340 | about 150 | about 150 | 1 |
| Combustibility | slightly | slightly | slightly | slightly |
| | combustible | combustible | combustible | combustible |
| Disproportionation | absent (practically | absent (practically | absent (practically | absent |
| | usable range) | usable range) | usable range) | |
| Cooling | 100 | about 73 | about 63 | about 36 |
| performance | | | | |

The critical temperatures and GWPs given in Table 3 are calculated using the values in Table 1. To evaluate the properties of the refrigerants of Examples 1 and 2, cooling performances of refrigeration cycle devices using the refrigerants of Examples 1 and 2 were calculated. The “cooling performance” can also be said as a refrigeration capacity of a refrigeration cycle device. The cooling performances of Examples 1 and 2 in Table 3 were each determined by calculating a cooling capacity by the following calculation method, and indicating the cooling capacity as a relative percentage as determined while the cooling capacity of Comparative Example 1 is defined as 100%.

Calculation Method of Cooling Capacity

Each cooling capacity was calculated from the enthalpy (h) of each refrigerant and the density (ρ) of each refrigerant at a compressor inlet position, where the refrigerant condensing temperature is defined at about 50° C., and the evaporating temperature is defined at about 0° C.

Cooling capacity=(h1−h2)×ρ

In the expression, h1 is the enthalpy of the refrigerant after discharged from the evaporator 104; and h2 is the enthalpy of the refrigerant before flowing into the evaporator 104.

As presented in Table 3, the refrigerant of Example 1 uses HFO-1234ze (E) alone as the HFO-1234ze. The refrigerant of Example 1 has a mixing ratio of HFO-1123 to HFC-32 of 6:4. The refrigerant of Example 1 has a mass proportion of HFO-1234ze of 45.0 mass percent relative to the total mass of the three components, where the total mass of the three components is defined as 100 mass percent. The mixing ratio in Example 1 corresponds to Point A1 in FIG. 5.

(1) GWP

The refrigerant of Example 1 has a GWP of about 150 and meets the required condition of GWP of 150 or less.

(2) Critical Temperature

As described above, it is desirable for an on-vehicle refrigerant to maintain the refrigerant condensing temperature at a level equal to or lower than the critical temperature even in the Middle and Near East and other areas where an ambient temperature is extremely high. When the outside air temperature is 50° C., the condensing temperature becomes 75° C. to 85° C. The refrigerant therefore desirably has a critical temperature of 85° C. or higher.

The refrigerant of Example 1 has a critical temperature of about 86° C. and meets the target condition in critical technology of 85° C. or higher.

(3) Combustibility

The refrigerant of Example 1 includes HFC-32 in a smaller amount and HFO-1234ze (E) in a larger amount, as compared with the two-component mixture refrigerant including HFO-1123 and HFC-32 in a mixing ratio of HFO-1123 to HFC-32 of 6:4. The refrigerant of Example 1 therefore has lower combustibility.

(4) Cooling Performance

As demonstrated in Table 3, the refrigerant of Example 1 can maintain its cooling performance at a level of about 73% relative to the cooling performance of the mixture refrigerant of Comparative Example 1. The refrigerant of Example 1 has a cooling performance of about 2 times as much as the cooling performance of HFO-1234yf which is used as an on-vehicle refrigerant at present. Accordingly, the refrigerant of Example 1, when used, can contribute to significantly better performance of on-vehicle air conditioners.

There is such a trade-off relationship that the critical temperature is raised, but the cooling performance is lowered with an increase in mixing proportion of HFO-1234ze relative to the total amount of the three components. The mixing ratio specified in Example 1 is such a mixing ratio as to maintain the cooling performance of the refrigerant at a maximum level while the refrigerant is controlled to have a GWP of 150 or less and to have a critical temperature of 85° C. or higher.

(5) Disproportionation

The refrigerant of Example 1 includes HFO-1123 and its pseudo-azeotropic refrigerant HFC-32 in a mixing ratio of HFO-1123 to HFC-32 of from 4:6 to 6:4 and thereby less undergoes the disproportionation of HFO-1123, as described above.

The refrigerant of Example 1 includes HFO-1123 and HFC-32 in a mixing ratio of HFO-1123 to HFC-32 of from 4:6 to 6:4 in an operation state of the refrigeration cycle device 100. In addition, HFO-1123 in the refrigerant of Example 1 is diluted (lowered in concentration) with HFO-1234ze. This also allows the refrigerant according to Example 1 to less undergo the disproportionation of HFO-1123.

In a halt state of the refrigeration cycle device 100, the components in the refrigerant may be unevenly distributed to cause HFO-1234ze alone to be discharged to the outside. Even in this case, the refrigerant of Example 1 less undergoes the disproportionation of HFO-1123, because HFO-1123 and HFC-32 are maintained in a mixture state with each other, and the refrigerant has a mixing ratio of HFO-1123 to HFC-32 of from 4:6 to 6:4.

The refrigerant of Example 2 uses HFO-1234ze (E) alone as the HFO-1234ze, as presented in Table 3. The refrigerant of Example 2 includes HFO-1123 and HFC-32 in a mixing ratio of HFO-1123 to HFC-32 of 4:6. The refrigerant of Example 2 includes HFO-1234ze in a mass proportion of 63.8% relative to the total amount of the three components. The mass proportion herein refers to a mass proportion as determined while the total mass of the three components is defined as 100 mass percent. The mixing ratio specified in Example 2 corresponds to Point A2 in FIG. 5.

The refrigerant of Example 2 maintains a GWP in a mixture state at a level of 150 or less and still has a higher critical temperature of about 95° C., as compared with the refrigerant of Example 1. In contrast, the refrigerant of Example 2 includes the HFO-1234ze (E) component in a larger proportion and thereby has a slightly lower cooling performance, as compared with the refrigerant of Example 1. However, the refrigerant of Example 2 has a cooling performance of about 1.74 times as much as the cooling performance of HFO-1234yf. The refrigerant of Example 2, when used, can contribute to significantly better performance of on-vehicle air conditioners.

### Second Embodiment

The refrigerant according to the present embodiment further includes HFO-1234yf (2,3,3,3-tetrafluoro-1-propene), in addition to the three components of the refrigerant according to the first embodiment. That is, the refrigerant of the present embodiment is a four-component mixture of HFO-1123, HFC-32, HFO-1234ze, and HFO-1234yf which are present as principal components in a mixture state.

HFO-1234yf has an extremely lower GWP of 1 than the GWP (675) of HFC-32, as presented in Table 1. HFO-1234yf has an extremely high critical temperature of 94.7° C., as compared with the critical temperatures (59.2° C. and 78.1° C.) respectively of HFO-1123 and HFC-32. HFO-1234yf has a lower burning rate as compared with HFC-32.

The refrigerant of the present embodiment also offers similar advantages in GWP, critical temperature, and combustibility to the refrigerant of the first embodiment.

HFO-1234yf has a GWP at the same level with the GWP of HFO-1234ze. The refrigerant of the present embodiment can therefore have a GWP of 150 or less in a mixture state of the principal components, by appropriately adjusting the mixing ratio of the four components, as in the refrigerant of the first embodiment. The range of the mixing ratio of the four component so as to allow the refrigerant to have a GWP of 150 or less is the same as with the range of the mixing ratio of the three components described in the first embodiment, except for replacing the mass proportion of HFO-1234ze with the total mass proportion of HFO-1234ze and HFO-1234yf in combination.

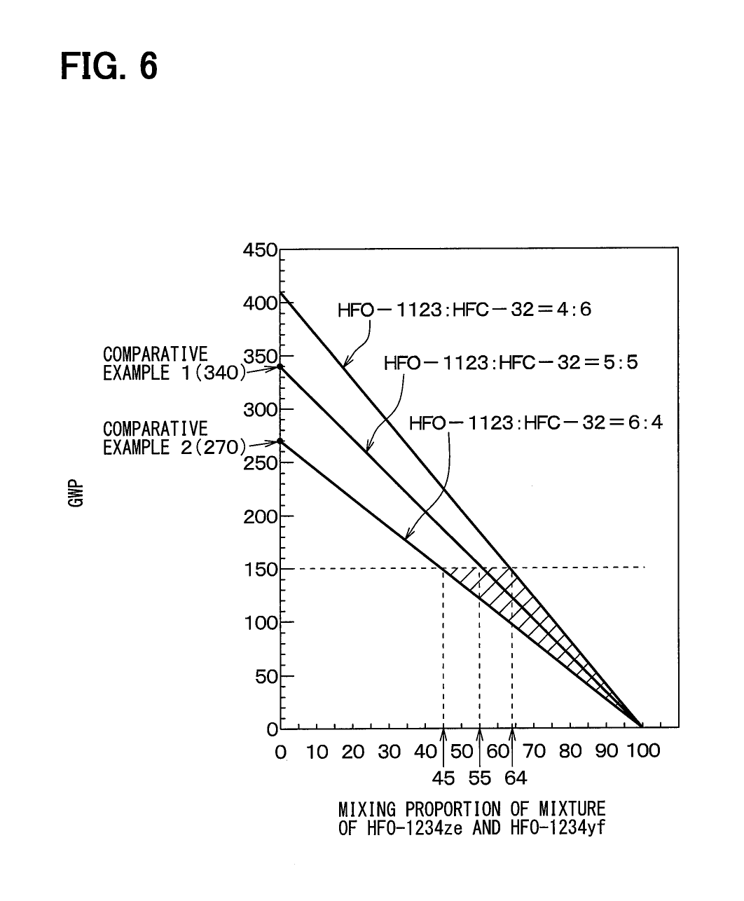

Specifically, the mixing ratio of the four components is adjusted so that the total mass proportion of HFO-1234ze and HFO-1234yf in combination is 45 mass percent or more relative to the total mass of the four components at a mixing ratio of HFO-1123 to HFC-32 of from 4:6 to 6:4, as illustrated in FIG. 6. The mixing proportion herein refers to a mixing proportion as determined while the total mass of the four components is defined as 100 mass percent. However, the total mixing proportion of HFO-1234ze and HFO-1234yf in combination is adjusted to about 55 mass percent or more at a mixing ratio of HFO-1123 to HFC-32 of 5:5. As described above, the mixing ratio among the four components is adjusted within such a range as to allow the refrigerant to have a GWP of 150 or less. The total mixing proportion of HFO-1234ze and HFO-1234yf in combination is adjusted to about 64 mass percent or more at a mixing ratio of HFO-1123 to HFC-32 of 4:6. As described above, the mixing ratio of the four components is adjusted within such a range as to allow the refrigerant to have a GWP of 150 or less. This configuration allows the refrigerant to have a GWP of 150 or less in a mixture state of the four components.

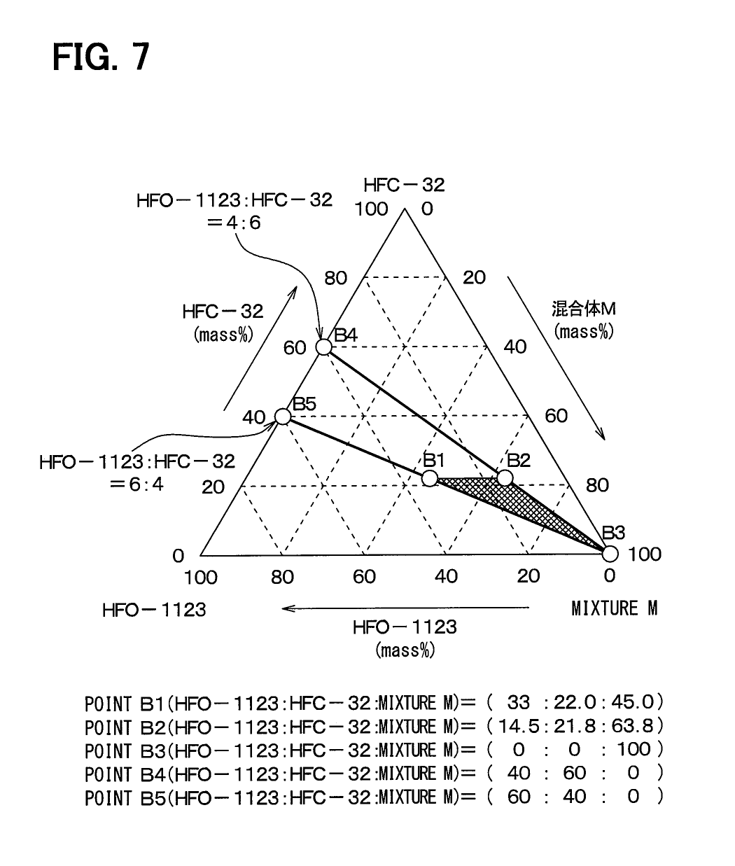

The triangular diagram in FIG. 7 is plotted in which the total mass of the four components is defined as 100 mass percent, and points at which the mass proportion of one of HFO-1123 alone, HFC-32 alone, and a mixture M is 100 mass percent are defined as vertices. The mixture M is a mixture (total) of HFO-1234ze and HFO-1234yf in combination. On the triangular diagram in FIG. 7, there is plotted such a region that the refrigerant has a GWP of 150 or less in a mixture state of the four components, at a mixing ratio of HFO-1123 to HFC-32 of from 4:6 to 6:4.

The mixing ratio among the four components is adjusted so as to fall within the crosshatched region surrounded by straight lines connecting Point B1, Point B2, and Point B3 in the specified sequence in the triangular diagram illustrated in FIG. 7, where the region includes the individual straight lines, but excludes Point B3. This allows the refrigerant to have a GWP of 150 or less in a mixture state of the four components. Point B1, Point B2, and Point B3 are expressed as follows.

Point B1: (HFO-1123:HFC-32:Mixture M=33:22.0:45.0)

Point B2: (HFO-1123:HFC-32:Mixture M=14.5:21.8:63.8)

Point B3: (HFO-1123:HFC-32:Mixture M=0:0:100)

Also in FIGS. 6 and 7, when the HFO-1234ze includes both HFO-1234ze (E) and HFO-1234ze (Z) in combination, the term “mass proportion of HFO-1234ze” refers to the mass proportion of the total mass of the two isomers.

Table 4 presents data of a refrigerant of Example 3. The mixing proportions given in Table 4 are proportions as determined while the total mass of the four components is defined as 100 mass percent.

TABLE 4

| | Example 3 | | | |
|---|---|---|---|---|
| | HFO1123 | HFC32 | HFO1234ze(E) | HFO1234yf |
| Mixing ratio | 32 | 21.3 | 33.0 | 13.7 |
| (mass percent) | | | | |

| | |
|---|---|
| Critical | around 85° C. |
| temperature (° C.) | |
| GWP | about 145 |
| Combustibility | slightly combustible |
| Disproportionation | absent (practically usable range) |
| Cooling | about 73 |
| performance | |

The refrigerant of Example 3 includes HFO-1123 and HFC-32 in mixing proportions approximately identical to those of the refrigerant of Example 1. The refrigerant of Example 3 further includes 13.7% of HFO-1234yf which has a boiling point relatively close to the boiling points of HFO-1123 and HFC-32. The refrigerant of Example 3 is controlled to have a lower mixing proportion of HFO-1234ze of 33.0% as compared with the refrigerant of Example 1, where HFO-1234ze has a boiling point significantly different from the boiling points of HFO-1123 and HFC-32.

The refrigerant of Example 3, as having the mixing ratio (mixing proportions), can maintain performance at a level similar to that in the refrigerant of Example 1 and can still less undergo temperature glide.

The “temperature glide” refers to gradual changes of an evaporating temperature and a condensing temperature respectively in an evaporation process and a condensation process of the refrigerant. HFO-1234ze has a boiling point significantly different from the boiling points of HFO-1123 and HFC-32. This may cause the refrigerant including HFO-1123, HFC-32, and HFO-1234ze as principal components to undergo temperature glide. To eliminate or minimize this, part of HFO-1234ze which has a boiling point significantly different from the boiling points of HFO-1123 and HFC-32 is replaced with HFO-1234yf which has a boiling point relatively close to the boiling points of HFO-1123 and HFC-32, as with the refrigerant of Example 3. This configuration allows the resulting refrigerant to maintain desired properties and to still less undergo temperature glide.

The refrigerant of Example 1 is estimated to have a temperature glide of about 12° C. to about 5° C. In contrast, the refrigerant of Example 3 is estimated to have a temperature glide of 10° C. to 3.3° C. Thus, the refrigerant less undergo temperature glide and can thereby maintain a more homogeneous evaporating temperature particularly in the evaporator 104, and this allows the cooled air to have a uniformized temperature.

The mixing ratio in the refrigerant of the present embodiment is not limited to the mixing ratio specified in Example 3, but may also be another mixing ratio.

### Other Embodiments

The present disclosure is not intended to be limited to the embodiments mentioned above and can be modified as appropriate within the scope and spirit as set forth in the appended claims. The present disclosure also accepts modifications of the embodiments, and equivalent variations thereof, as mentioned below.

(1) In the embodiments, the working medium of the present disclosure is applied to a refrigerant for use in a vapor compression refrigeration cycle device of an on-vehicle air conditioner, but the working medium may also be applied to refrigerants for use in on-vehicle refrigeration cycle devices other than on-vehicle air conditioners, and to refrigerants for use in other heat cycle devices. Non-limiting examples of the other heat cycle devices include Rankine cycle devices, heat pump cycle devices, and heat transport devices.

(2) The embodiments are not irrelevant to each other, but can be combined as appropriate, unless the combination is apparently impossible. Needless to say, in each of the above embodiments, the components constituting the embodiment are not necessarily essential except typically in the case where they are clearly specified as particularly essential or considered to be obviously essential in principle.

What is claimed is:

1. A working medium for a heat cycle, the working medium comprising:
HFO-1123;
HFC-32; and
HFO-1234ze, wherein
the HFO-1123, the HFC-32, and the HFO-1234ze, which are referred to as three components, are present as principal components in a mixture state.

2. The working medium for a heat cycle according to claim 1, wherein
the three components are present in respective mixing proportions such that a GWP of the three components in the mixture state is 150 or less.

3. The working medium for a heat cycle according to claim 2, wherein
the HFO-1123 and the HFC-32 are present in a mass ratio of the HFO-1123 to the HFC-32 of from 4:6 to 6:4, and
the HFO-1234ze is present in a mass proportion of 45 mass percent or more relative to a total mass of the three components.

4. The working medium for a heat cycle according to claim 1, wherein
in a triangular diagram in which a total mass of the three components is defined as 100 mass percent and in which points at each of which a mass proportion of one of the three components is 100 mass percent are defined as vertices,
mass proportions of the three components each fall within a region surrounded by straight lines connecting a point A1, a point A2 and a point A3 in a specified sequence, and including the straight lines, but excluding the point A3, in which
the point A1 satisfies a mass ratio of HFO-1123:HFC-32:HFO-1234ze=33:22.0:45.0,
the point A2 satisfies a mass ratio of HFO-1123:HFC-32:HFO-1234ze=14.5:21.8:63.8, and
the point A3 satisfies a mass ratio of HFO-1123:HFC-32:HFO-1234ze=0:0:100.

5. The working medium for a heat cycle according to claim 1, wherein
the HFO-1234ze comprises HFO-1234ze (E) alone.

6. The working medium for a heat cycle according to claim 1, wherein
the HFO-1234ze comprises both HFO-1234ze (E) and HFO-1234ze (Z) in combination.

7. The working medium for a heat cycle according to claim 1, further comprising
HFO-1234yf, wherein
the HFO-1123, the HFC-32, the HFO-1234ze, and the HFO-1234yf, which are referred to as four components, are present as principal components in a mixture state.

8. The working medium for a heat cycle according to claim 7, wherein
the four components are present in respective mixing proportions such that a GWP of the four components in the mixture state is 150 or less.

9. The working medium for a heat cycle according to claim 8, wherein
the HFO-1123 and the HFC-32 are present in a mass ratio of the HFO-1123 to the HFC-32 of from 4:6 to 6:4, and
a total mass proportion of the HFO-1234ze and the HFO-1234yf in combination is 45 mass percent or more relative to a total mass of the four components.

10. The working medium for a heat cycle according to claim 7, wherein
in a triangular diagram in which a total mass of the four components is defined as 100 mass percent and in which points at each of which a mass proportion of one of the HFO-1123 alone, the HFC-32 alone, and a total of the HFO-1234ze and the HFO-1234yf is 100 mass percent are defined as vertices,
mass proportions of the four components each fall within a region surrounded by straight lines connecting a point B1, a point B2 and a point B3 in a specified sequence and including the straight lines, but excluding the point B3, in which
the point B1 satisfies a mass ratio of HFO-1123:HFC-32:HFO-1234ze and HFO-1234yf in total=33:22.0:45.0,
the point B2 satisfies a mass ratio of HFO-1123:HFC-32:HFO-1234ze and HFO-1234yf in total=14.5:21.8:63.8, and
the point B3 satisfies a mass ratio of HFO-1123:HFC-32:HFO-1234ze and HFO-1234yf in total=0:0:100.

11. The working medium for a heat cycle according to claim 7, wherein
the HFO-1234ze comprises HFO-1234ze (E) alone.

12. The working medium for a heat cycle according to claim 7, wherein
the HFO-1234ze comprises both HFO-1234ze (E) and HFO-1234ze (Z) in combination.
